(19) United States
(12) Patent Application Publication
(10) Pub. No.: US 2017/0365256 A1
(43) Pub. Date: Dec. 21, 2017

(54) SPEECH PROCESSING SYSTEM AND SPEECH PROCESSING METHOD

(71) Applicant: Kabushiki Kaisha Toshiba, Minato-ku (JP)

(72) Inventors: Ioannis STYLIANOU, Cambridge (GB); Petko Petkov, Cambridge (GB); Norbert Braunschweiler, Cambridge (GB)

(73) Assignee: Kabushiki Kaisha Toshiba, Minato-ku (JP)

(21) Appl. No.: 15/439,233

(22) Filed: Feb. 22, 2017

(30) Foreign Application Priority Data
Jun. 17, 2016 (GB) 1610623.9

(51) Int. Cl. G10L 15/20; G10L 15/14; G10L 15/02; G10L 25/21; G10L 25/87

(52) U.S. Cl. CPC G10L 15/20; G10L 25/21; G10L 25/87; G10L 15/02; G10L 15/142; G10L 2015/025

(57) ABSTRACT

A speech intelligibility enhancing system for enhancing speech, the system comprising:
a speech input for receiving speech to be enhanced;
an enhanced speech output to output the enhanced speech; and
a processor configured to convert speech received by the speech input to enhanced speech to be output by the enhanced speech output,
the processor being configured to:
   extract a portion of the speech received by the speech input;
   calculate the power of the portion;
   estimate a contribution due to late reverberation to the power of the portion of the speech when reverbed;
   calculate a target late reverberation power;
   determine a time tᵢ for the estimated contribution due to late reverberation to decay to the target late reverberation power;
   calculate a pause duration, wherein the pause duration is calculated using the time tᵢ;
   insert a pause having the calculated duration into the speech received by the speech input at a first location, wherein the first location is followed by the portion.

### FIELD

The present disclosure relates to speech processing systems and speech processing methods.

### BACKGROUND

Reverberation is a process under which acoustic signals generated in the past reflect off objects in the environment and are observed simultaneously with acoustic signals generated at a later point in time. It is often necessary to understand speech in reverberant environments such as train stations and stadiums, large factories, concert and lecture halls. Speech intelligibility in reverberant environments may be reduced because of overlap-masking, i.e., multiple, delayed and attenuated copies of an acoustic signal are observed simultaneously.

It is possible to enhance a speech signal such that it is more intelligible in such environments. Signal modification prior to presentation in such listening environments, for example with a public announcement system, can be employed.

### BRIEF DESCRIPTION OF THE DRAWINGS

Systems and methods in accordance with non-limiting arrangements will now be described with reference to the accompanying figures in which:

FIG. 1 is a schematic of a speech intelligibility enhancing system;

FIG. 2 is a flow diagram showing a method of enhancing speech;

FIG. 3 shows three plots relating to modelling of the late reverberation;

FIG. 4 shows a flow chart of a method of calculating a pause strength;

FIG. 5 illustrates some example functions which may be used to calculate the pause strength value using the measure of suitability;

FIG. 6 shows three output waveforms, where the first waveform is natural speech, the second waveform is modified using a binary pause strength and the third waveform is modified using a continuous pause strength;

FIG. 7 shows the average word recognition rates over all test participants and standard errors for natural speech, speech modified using a binary pause strength and speech modified using a continuous pause strength.

### DETAILED DESCRIPTION

According to one example, there is provided a speech intelligibility enhancing system for enhancing speech, the system comprising:
a speech input for receiving speech to be enhanced;
an enhanced speech output to output the enhanced speech; and
a processor configured to convert speech received by the speech input to enhanced speech to be output by the enhanced speech output,
the processor being configured to:
   extract a portion of the speech received by the speech input;
   calculate the power of the portion;
   estimate a contribution due to late reverberation to the power of the portion of the speech when reverbed;
   calculate a target late reverberation power;
   determine a time tᵢ for the estimated contribution due to late reverberation to decay to the target late reverberation power;
   calculate a pause duration, wherein the pause duration is calculated using the time tᵢ;
   insert a pause having the calculated duration into the speech received by the speech input at a first location, wherein the first location is followed by the portion.

Inserting pauses into a speech signal reduces overlap masking caused by late reverberation. In this system, the duration of the pause reflects the level of late reverberation, resulting in improved intelligibility.

In an embodiment, the portion corresponds to at least the first part of a word. The first location is thus followed by the word. The portion may correspond to the first sound transition of a word or a fixed time window at the start of a word for example.

The portion may be extracted by determining segmentation information using text corresponding to the speech received by the speech input and then identifying the start and end location of the portion from the segmentation information.

In an embodiment, the speech signal comprises a sentence comprising a sequence of words. Phoneme segmentation information is determined for the sentence, from the input speech signal and the text. The start of the initial portion is identified as the start of the left-hand-side context of the first phoneme in the sentence and the end of the initial portion is identified as the right-hand-side context of the second phoneme. This portion is processed by the system, and a pause duration calculated for the location followed by the left-hand-side context of the first phoneme. The start of the next portion is then identified as the start of the left-hand-side context of the first phoneme in the second word in the sentence and the end of the next portion is identified as the right-hand-side context of the second phoneme in the second word in the sentence. This portion is processed by the system, a pause duration calculated, the next portion identified and so on. After the portions corresponding to all of the words in the sentence have been processed, phoneme segmentation is determined for the next sentence in the speech signal, and so on.

The text may be inputted separately or extracted from the speech received by the speech input using automatic speech recognition for example.

Where the text is inputted separately, the segmentation information may be determined using forced alignment using pre-trained Gaussian mixture model Hidden Markov Models (GMM-HMMs).

In an embodiment, calculating the pause duration comprises:
determining a measure of the suitability for inserting a pause at the first location, using text corresponding to the speech received by the speech input;
wherein the pause duration is calculated using the time tᵢ and the measure of the suitability.

In an embodiment, the speech signal comprises a sentence comprising a sequence of words. The measure of suitability is determined for each location followed by a word in the sentence. The time tᵢ is calculated for the location followed by the first word in the sentence, a pause duration calculated using the time the tᵢ and the measure of suitability, and the pause is inserted at the location. The time tᵢ is then calculated for the location followed by the next word in the sentence, a pause duration calculated using the time the tᵢ and the measure of suitability, and the pause is inserted at the location and so on. After a pause duration has been calculated for all the locations followed by the words in the sentence, the measures of suitability are determined for each location followed by a word in the next sentence in the speech signal, and so on.

Determining the measure of suitability may comprise determining, from the text corresponding to the speech received by the speech input, whether the first location corresponds to a prosodic break in the text, wherein the measure of suitability is higher if the first location corresponds to a prosodic break.

Determining the measure of suitability may further comprises determining, from the text corresponding to the speech received by the speech input, whether the word satisfies one or more conditions from a pre-determined set comprising one or more conditions, wherein the conditions relate to features of the text.

In an embodiment, determining the measure of suitability comprises:
allocating a first parameter a value of 0 if the first location does not correspond to a prosodic break and a pre-determined value of greater than zero if it does correspond to a prosodic break;
allocating a value to a further parameter corresponding to each condition in the set, wherein the allocated value is zero if the word does not satisfy the condition and a pre-determined value other than zero if the word does satisfy the condition;
calculating a value for the measure of the suitability by combining the values of the first parameter and the further parameters.

In an embodiment, the speech received by the speech input comprises a sentence which is a sequence of words, and the processor is configured to:
determine a measure of suitability for inserting a pause at each location followed by a word in the sentence;
determine whether the sentence comprises a sequence of two or more adjacent words for which the measure of suitability for inserting a pause at a location followed by the word is greater than a first threshold value;
if there is such a sequence, re-evaluate the measures of suitability for the sequence.

In an embodiment, the processor is also or alternatively configured to:
determine a measure of suitability for inserting a pause at each location followed by a word in the sentence;
determine whether the sentence comprises a sequence of six or more adjacent words for which the measure of suitability for inserting a pause at a location followed by the word is less than a second threshold value;
if there is such a sequence, re-evaluate the measures of suitability for the sequence.

In an embodiment, calculating the pause duration comprises:
calculating a pause strength value wᵢ using the measure of suitability;
wherein the pause duration is calculated by multiplying the time tᵢ by the pause strength value wᵢ.

Calculating the pause strength value wᵢ may comprise assigning a pause strength value wᵢ of 1 when the measure of suitability is greater than or equal to a third threshold value I_{b} and assigning a pause strength value wᵢ of 0 when the measure of suitability is less than the third threshold value I_{b}.

Calculating the pause strength value wᵢ may alternatively comprise assigning a pause strength value wᵢ of 0 when the measure of suitability is less than a third threshold value I_{b}, and calculating a pause strength value wᵢ from a monotonically increasing function of the measure of suitability when the measure of suitability is greater than or equal to the third threshold value I_{b}.

In an embodiment, the time tᵢ is calculated using an exponential decay function. Calculating the time tᵢ may comprise:
calculating the logarithm of the target late reverberation power divided by the estimated contribution due to late reverberation to the power of the portion of the speech when reverbed;
scaling this calculated value using a reverberation time to give a decay time value;
wherein the time tᵢ is calculated as the maximum of the decay time value and 0.

In an embodiment, the target late reverberation power is calculated using the power of the portion and a target signal to late reverberation ratio.

The contribution due to late reverberation is the late reverberation, of a previous section of the outputted speech signal, which coincides in time with the portion of the speech signal.

In an embodiment, the contribution due to late reverberation is estimated by:
modelling the impulse response of the environment as a pulse train that is amplitude-modulated with a decaying function;
taking the convolution of a section of the impulse response and a section of the enhanced speech signal located a time before the portion to give a model late reverberation signal for the portion;
calculating the power of the model late reverberation signal.

The location followed by the portion is the location at the beginning, or start, of the portion. In an embodiment, the location is the first frame associated with the left-hand-side context of the first phoneme in a word. The location is preferably exactly at the beginning of the portion, i.e. immediately before the portion, but may optionally include preceding it by a duration which may be pre-set or automatically determined and is less than a typical duration between words.

According to another example, there is provided a method of enhancing speech, comprising:
extracting a portion of speech received by a speech input;
calculating the power of the portion;
estimating a contribution due to late reverberation to the power of the portion of the speech when reverbed;
calculating a target late reverberation power;
determining the time it for the estimated contribution due to late reverberation to decay to the target late reverberation power;
calculating a pause duration, wherein the pause duration is calculated using the time tᵢ;
inserting a pause having the calculated duration into the speech received by the speech input at a first location, wherein the first location is followed by the portion.

According to another example there is provided a carrier medium comprising computer readable code configured to cause a computer to perform a method of enhancing speech, comprising:
extracting a portion of speech received by a speech input;
calculating the power of the portion;
estimating a contribution due to late reverberation to the power of the portion of the speech when reverbed;
calculating a target late reverberation power;
determining the time tᵢ for the estimated contribution due to late reverberation to decay to the target late reverberation power;
calculating a pause duration, wherein the pause duration is calculated using the time tᵢ;
inserting a pause having the calculated duration into the speech received by the speech input at a first location, wherein the first location is followed by the portion.

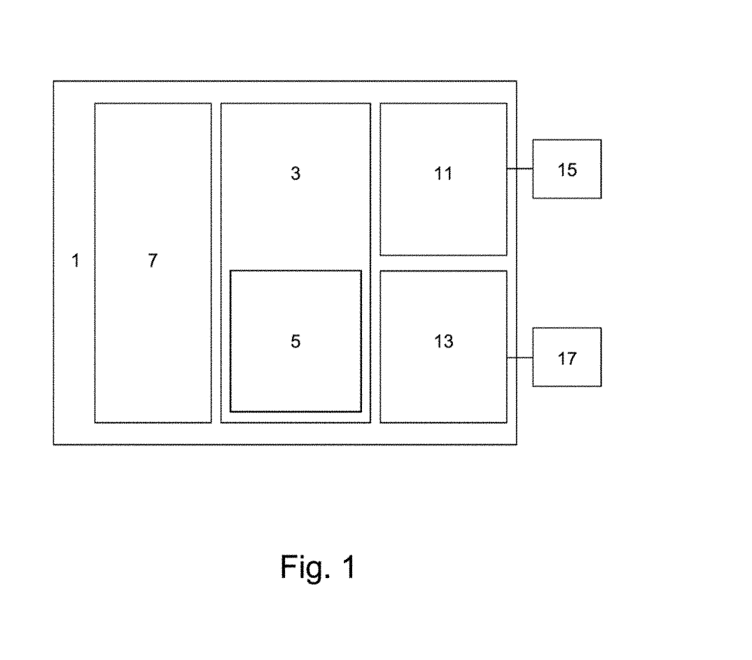

FIG. 1 is a schematic of a speech intelligibility enhancing system 1 in accordance with an embodiment.

The system 1 comprises a processor 3 comprising a program 5 which takes input speech and enhances the speech to increase its intelligibility. The storage 7 stores data that is used by the program 5.

The system 1 further comprises an input module 11 and an output module 13. The input module 11 is connected to a speech input 15 for data relating to the speech to be enhanced. The input 15 may be an interface that allows a user to directly input data. Alternatively, the input may be a receiver for receiving data from an external storage medium or a network. The input 15 may receive data from a microphone for example. The input speech signal may be acoustic, analogue or digital and may be recorded natural speech or synthesized speech for example.

Connected to the output module 13 is speech output 17. The output 17 may be a speaker for example, or a transmitter for transmitting data.

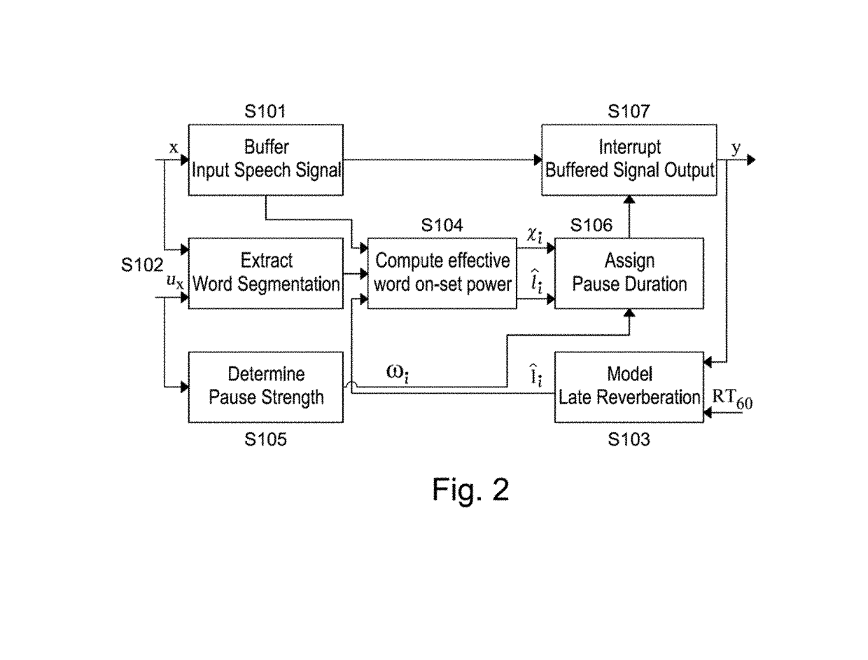

In use, the system 1 receives data through input 15. The program 5, executed on processor 3, enhances the inputted speech in the manner which will be described with reference to FIGS. 2 to 7. The enhanced speech is then outputted through output module 13.

The system realizes pause insertion, for recorded natural speech or synthesized speech, for example generated by a text-to-speech system.

FIG. 2 shows a flow chart of a method of enhancing speech in accordance with an embodiment. In an embodiment, the processor 3 is configured to execute this method.

In step S101, a speech signal x is received by the speech input 15. Step S101 is “Buffer input speech signal”. In this step, the input speech signal may be stored in the storage 7. The input speech signal is stored so that when pauses are inserted into the signal, and this “interrupts” the output, the continually inputted speech signal may be stored until processed and outputted.

A portion xᵢ of the speech signal x received by the speech input is extracted for processing. i represents the index of the portion.

In an embodiment, the portion xᵢ is at least the first part of a word. In this case, i represents the word index. In this case, in order to extract the portion, the boundaries of the words must first be located in the speech signal. In a further embodiment, the portion may start from the left-hand-side context of the first phoneme in a word and end with the right-hand-side context of the second phoneme in the word. In this case, in order to extract the portion, the start and end of the phonemes in the words must first be located in the speech signal.

S102 comprises determining segmentation information. The segmentation information may comprise the word boundaries. For example, the segmentation information may comprise the start and stop locations for individual tri-phone sound models. In this case, each tri-phone is represented by a sequence of states for which the alignment information indicates the starting and the ending location in the speech signal.

In an embodiment, the speech signal x may comprise a sentence which is a sequence of words, and the segmentation information for the entire sentence is determined in one step. Then, each portion in the sentence is extracted in turn, and processed in steps S104 onwards. Thus the segmentation information may be determined once for each sentence, and each portion in the sentence extracted in turn using the stored segmentation information.

In step S102, word segmentation information is determined using text uₓ corresponding to the speech x received by the speech input 15. The text uₓ may be inputted into the speech intelligibility enhancing system 1 separately from the speech signal x, for example, it may be inputted through a text input connected to a text input module. The text input may be an interface that allows a user to directly input text data, for example a key board. Alternatively, the input may be a receiver for receiving text data from an external storage medium or a network.

In an embodiment, forced alignment using pre-trained Gaussian mixture model Hidden Markov Models (GMM-HMMs) determines the segmentation information from the text uₓ and the speech signal x. Forced alignment matches frames extracted from the speech signal to acoustic models representing distinct parts of a phoneme. The acoustic models are implemented as GMMs and the sequence of models is identified given the input text. Forced alignment may be performed using monophone or triphone models for example. In both cases a phoneme state is represented by a sequence of three acoustic models. When using tri-phones, the states are referred to as left context, centre state and right context. Each tri-phone state may correspond to more than one frame in the speech signal. Transition probabilities between adjacent states, inferred from training data, complete a GMM-HMM model.

In an embodiment, forced alignment is achieved by using modules from a pre-trained GMM-HMM automatic speech recognition (ASR) engine, implemented based on HTK for example. HMMs are trained using a training speech corpus. The ASR engine comprises a set of acoustic models, each corresponding to a phoneme, and associated transition probabilities. Model parameters are trained using speech corpora with text transcriptions. Training and validation of the ASR engine is performed prior to deploying the intelligibility enhancing system.

Once the system is deployed, i.e. in use, the speech signal from the input 15 and the text uₓ are processed by the ASR engine components. Overlapping frames are extracted from the speech signal. Forced alignment is achieved by identifying the frame-to-model allocation that maximizes the posterior probability of the known phonetic sequence. This involves extracting feature vectors from the signal frames and computing the likelihood of the feature vectors given acoustic models determined by the phonetic transcription. The result is that the overlapping frames extracted from the speech signal are assigned to specific acoustic models, which in turn provide the beginning and end time stamps for each phoneme sub-state, i.e., left context, centre state and right context. This is the segmentation information.

The speech intelligibility enhancing system 1 may operate in combination with a text-to-speech system for example. Such a system comprises a text input and a text-to-speech module, configured to generate and output a speech signal x from text uₓ inputted at the text input. The speech signal x outputted from the text-to-speech module is then inputted into the speech input 15 of the speech intelligibility enhancing system. Segmentation information is generated as part of the speech synthesis process. As a result, forced alignment need not be applied for the case of modification of synthetic speech.

Alternatively, the text uₓ corresponding to the speech signal x may be extracted from the speech signal x itself, for example using ASR. As the speech signal was used to extract the text uₓ, segmentation information is then obtained directly from the ASR output.

The ASR engine may be HTK-based and comprise GMM-HMMs pre-trained on speech corpora, as described above. Alternatively, a DNN-HMM based system can be used to produce sound segmentation information. A KALDI-based system can be used for this purpose.

Once the system is deployed, i.e. in use, the speech signal from the input 15 is processed by the ASR engine. In an embodiment, feature vectors are extracted from overlapping frames of duration 25 ms at a rate of 100 frames per second. Using an appropriate language model, the most probable sequence of words is identified using the pre-trained HMMs and the feature vectors. Phoneme segmentation information at the state level is obtained as a result of the recognition process.

Obtaining accurate segmentation information results in reduced artefacts, which may be caused by splitting a sound in two for example. Use of synthesised speech as the speech input, for example speech which is generated by a text-to-speech system means that word segmentation by forced alignment is not used, and thus introduction of artefacts is avoided.

The output of S102 is the segmentation information.

In step S103, a model signal Î for the late reverberation of the speech signal when reverbed is generated.

Reverberation can be modelled as a convolution between the impulse response of the particular environment and the speech signal. The impulse response splits into three components: direct path, early reflections and late reverberation. Reverberation thus comprises two components: early reflections and late reverberation.

Early reflections have high power, depend on the geometry of the space and are individually distinguishable. They arrive within a short time window, for example 50 ms, after the direct sound and are easily distinguishable when examining the room impulse response (RIR). Early reflections depend on the hall geometry and the position of the speaker and the listener. Early reflections are not considered harmful to intelligibility, and in fact can improve intelligibility.

Late reverberation is diffuse in nature due to the large number of reflections and longer acoustic paths. Late reverberation is the contribution of reflections arriving after the early reflections. Identifying individual reflections is hard because their number increases while their magnitudes decrease. Late reverberation is composed of delayed and attenuated replicas that have reflected more times than the early reflections and comprise a large number of reflections with diminishing magnitudes. It is the primary factor for reduced intelligibility due to masking between neighbouring sounds. This can be relevant for communication in places such as train stations and stadiums, large factories, concert and lecture halls. Late reverberation is considered more harmful to intelligibility because it is the primary cause of masking between different sounds in the speech signal.

The boundary tᵢ between early reflections and late reverberation in a RIR is the point where distinct reflections turn into a diffuse mixture. The value of tᵢ is a characteristic of the environment. In an embodiment, tᵢ is in the range 50 to 100 ms after the arrival of the sound following the direct path, i.e. the direct sound. tᵢ seconds after the arrival of the direct sound, individual reflections become indistinguishable.

In one embodiment, the late reverberation can be modelled accurately to reproduce the acoustics of a particular hall. In alternative embodiments, simpler models that approximate the masking power due to late reverberation can be used, because the objective is power estimation of the late reverberation. Statistical models can be used to predict late reverberation power.

In an embodiment, the late reverberant part of the impulse response is modelled as a pulse train with exponentially decaying envelope. In an embodiment, the Velvet Noise model can be used to model the contribution due to late reverberation.

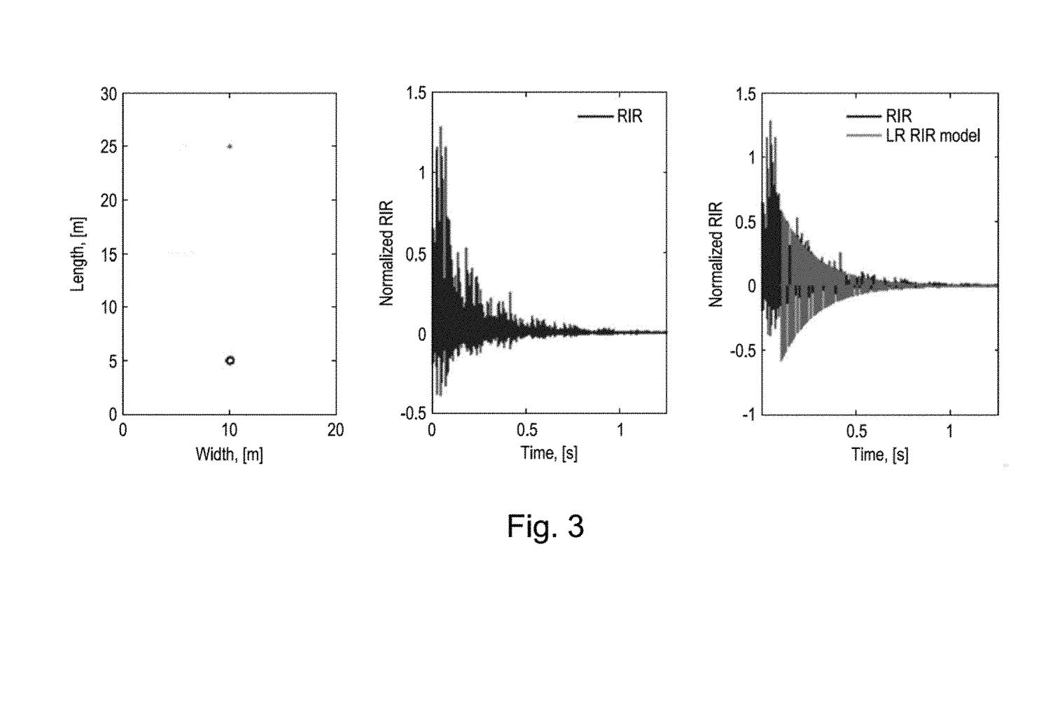

FIG. 3 shows three plots relating to use of the Velvet Noise model to model the late reverberation signal.

The first plot shows an example acoustic environment, which is a hall with dimensions fixed to 20 m×30 m×8 m, the dimensions being width, length and height respectively. Length is shown on the vertical axis and width is shown on the horizontal axis. The speaker and listener locations are {10 m, 5 m, 3 m} and {10 m, 25 m, 1.8 m} respectively. These values are used to generate the model RIR used for illustration of an RIR in the second plot. For the late reverberation power modelling, the particular locations of the speaker and the listener are not used.

The second plot shows a room impulse response where the propagation delay and attenuation are normalized to the direct sound. Time is shown on the horizontal axis in seconds. The normalized room impulse response shown here is a model RIR based on knowledge of the intended acoustic environment, which is shown in the first plot. The response is generated with the image-source method, given the dimensions of the hall shown in the first plot and a target RT₆₀. The reverberation time RT₆₀ is the time it takes late reverberation power to decay 60 dB below the power of the direct sound, and is also a characteristic of the environment. The particular locations of the speaker and the listener are not used to generate the response.

In an embodiment, the room impulse response may be measured, and the value of the boundary tᵢ and the reverberation time RT₆₀ can be obtained from this measurement.

The third plot shows the same normalised room impulse response as the second plot, as well as the portion of the pulse train model for the late reverberation part of RIR.

The model of the late reverberation is based on the assumption that the power of late reverberation decays exponentially with time. A pulse train with appropriate density is generated using the framework of the Velvet Noise model, and is amplitude modulated with a decaying function.

The late reverberation room impulse response model is obtained as a product of a pulse train t[k] and an envelope e[k]:

\tilde{h}[k]=t[k]e[k] (1)

where e[k] is given by equation (3) below, and t[k] is given by equation (2) below:

$$ι [ k ] = {\sum }_{m = 0}^{M} a [ m ] u [ k - round ( \frac{{T}_{d}}{{T}_{s}} ( m + rnd ( m ) ) ) ] \qquad ( 2 )$$

where a[m] is a randomly generated sign of value +1 or −1, md(m) is a random number uniformly distributed between 0 and 1, “round” denotes rounding to an integer, T_{d} is the average time in seconds between pulses and Tₛ is the sampling interval. u denotes a pulse with unit magnitude. This pulse train is the Velvet Noise model.

In an embodiment, the late reverberation pulse train is scaled. The energy of the modulated pulse train is equalized to the energy of the late reverberation part of an RIR calculated from a measurement for example. An initial value is chosen for the pulse density T_{d}. In an embodiment, an initial value of greater than 2000 pulses/second is used. In an embodiment an initial value of 4000 pulses/second is used. The pulse density is determined prior to the scaling step. The generated pulse train model of the late reverberation part of the RIR is then scaled to ensure that its energy is the same as the part of a measured RIR corresponding to late reverberation. A recording of an RIR for the acoustic environment may be used to scale the late reverberation pulse train. It is not important where the speaker and listener are situated for the recording. The values of tᵢ and RT₆₀ can be determined from the recording. The energy of the part of the RIR after tᵢ is also measured. The energy is computed as the sum of the squares of the values in the RIR after point tᵢ. The amplitude of the late reverberation pulse train is then scaled so that the energy of the late reverberation pulse train is the same as the energy computed from the RIR.

Any recorded RIR may be used for the scaling step, as long as it is from the target environment. Alternatively, a model RIR can be used.

The discretized envelope is given by:

$$e [ k ] = {10}^{- 3 \frac{k}{{RT}_{60 fs}}} \qquad ( 3 )$$

This relationship ensures a 60 dB power decay between the initial instant, t=0, which corresponds to the arrival of the direct path, and the reverberation time RT₆₀ instant. fₛ is the sampling frequency, where:

$${f}_{s} = \frac{1}{{T}_{s}} \qquad ( 4 )$$

The model of the late reverberation represents the portion of the RIR corresponding to late reverberation as a pulse train, of appropriate density, that is amplitude-modulated with a decaying function of the form given in (3). Specifically, the decaying function modulates the amplitude envelope, within which the sign of the pulses changes randomly. The model assumes the exponential decay of late reverberation power with time and a constant RT₆₀ over frequency is used.

An approximation to the late reverberation signal Î is given by the convolution of the modulated pulse train \tilde{h} and the output signal y:

$$\hat{l} [ k ] = {\sum }_{n = 1}^{( {RT}_{60} - {t}_{l} ) {f}_{s}} \tilde{h} [ {t}_{l} {f}_{s} + n ] y [ k - {t}_{l} {f}_{s} - n ] \qquad ( 5 )$$

where \tilde{h} is the late reverberation room impulse response model, given in (1), i.e. the artificial, pulse-train-based impulse response.

From equation (3), at k=0, e(t)=1, meaning there is no decay for the direct path, which is used as the reference. At k=RT₆₀/Tₛ, e(t)=10⁻³, which in the power domain corresponds to −60 dB.

y[k−tᵢfₛ−n] corresponds to a point in the output “buffer”, i.e. the already modified speech signal corresponding to a previous section of the speech signal. The convolution of \tilde{h} from tᵢ onwards and the signal history from the output buffer give a sample or model realization of the late reverberation signal.

The sample-based late reverberation model signal Î is obtained from Î [k] by considering a range of values for the parameter k. The signal Î is outputted from step S103.

In an embodiment, the segmentation information determined in S102 is used to identify the limits of the portion, and the late reverberation signal corresponding to the portion of the signal is calculated. The late reverberation signal in this case corresponds to the late reverberation of a previous section of the outputted speech signal, which coincides in time with the portion of the speech signal.

This is calculated by associating the beginning of the portion with time index k=0 in equation (5) above. The value of Î [k] for each value of k within the portion is then determined, resulting in a set of values Îᵢ, where each value corresponds to a value of k within the portion. These values form the model late reverberation signal for the portion, i.e. the late reverberation of a previous section of the outputted speech signal which coincides in time with the portion of the speech signal. The late reverberation model signal is the contribution to the portion of the input speech signal due to late reverberation.

In step S104, the segmentation information is used to identify the limits of the portion, such that the portion xᵢ is extracted from the speech signal. The power xᵢ of the portion of the speech signal xᵢ is then calculated. xᵢ denotes the signal power of the waveform xᵢ in the measurement window corresponding to the portion.

For example, the portion may be the whole word, or the first sound transition of a word, or a fixed time segment or window at the start of the word. For example, the portion may be the first 128 ms of a word. In practice, the first sound transition in the word may be the duration of the first two sounds, corresponding to six states starting from the left-hand-side context of the first phoneme and ending with the right-hand-side context of the second phoneme. Alternatively, it may be the portion ending at the left context of the second phoneme. For single-phoneme words, only three states are considered.

The late reverberation signal determined in S103 is then used to assess the late reverberation power. The late reverberation power is considered to have a negative impact on intelligibility. The contribution due to late reverberation to the power of the portion of the speech when reverbed is estimated from the late reverberation signal \hat{l}ᵢ. The contribution due to late reverberation to the power of the portion of the speech when reverbed \hat{l}ᵢ is simply the power of the model late reverberation signal \hat{l}ᵢ. In this step, an estimate of the late reverberation power \hat{l}ᵢ for the window of the portion prior to pause insertion is calculated from the late reverberation signal \hat{l}ᵢ.

In an embodiment, the power distribution of the portion of the input speech signal in a plurality of frequency bands can be used to estimate the late reverberation power. The frequency bands corresponding to the highest power bands corresponding to a predetermined fraction of the power of the portion are determined, and the fraction of the power of the late reverberation signal in each of these frequency bands is calculated. The contribution due to late reverberation to the power of the portion of the speech when reverbed in this case is the sum of the powers of the late reverberation signal in each of these frequency bands.

Alternatively, the contribution due to late reverberation to the power of the portion of the speech when reverbed \hat{l}ᵢ may be calculated as an exponential weighting of the power of previous speech segments for example.

Thus the values \hat{l}i and xᵢ are outputted from step S104.

In S106, a pause duration is calculated.

The method of speech modification described involves inserting a pause having the calculated duration into the speech received by the speech input at a first location, wherein the first location is followed by the portion. Thus for each portion, a pause duration is calculated in S106, and then a pause having the calculated duration is inserted into the location in the speech signal followed by the portion. For some of the locations, the calculated pause duration may be zero. For these locations, no pause is inserted, or equivalently, a pause having a duration of zero seconds is inserted.

S106 comprises calculating a target late reverberation power, wherein the target late reverberation power is calculated using the power of the portion xᵢ and determining the time tᵢ for the estimated contribution due to late reverberation to decay to the target late reverberation power. The pause duration is then calculated using the time tᵢ.

The time tᵢ is calculated by modelling the decrease of the late reverberation power with time as an exponential decay function. In an embodiment, calculating the time tᵢ comprises calculating the logarithm of the target late reverberation power divided by the estimated contribution due to late reverberation and scaling this calculated value using a reverberation time to give a decay time, wherein the time tᵢ is calculated as the maximum of the decay time value and 0.

In an embodiment, the target late reverberation power is determined from a target signal-to-late reverberation ratio (SLRR) criterion, where the portion of the speech signal determines the measurement window.

In an embodiment, the target late reverberation power is:

$${\tilde{l}}_{i} = {x}_{i} {10}^{\frac{- ɛ}{10}} \qquad ( 6 )$$

where ξ denotes the target SLRR, xᵢ denotes the signal power for the waveform xᵢ, which may include the first two sounds in word i for example.

Assuming an exponential decay of late reverberation power with time, the decay time value, is:

$$- \frac{{RT}_{60}}{6} {log}_{10} ( \frac{{\tilde{l}}_{i}}{{l}_{i}} ) \qquad ( 7 )$$

where lᵢ is the late reverberation power for the time window corresponding to xᵢ.

The time tᵢ for the estimated contribution due to late reverberation lᵢ to decay to the target late reverberation power \tilde{l}ᵢ is calculated from a simple model of exponential decay:

$${t}_{i} = max ( 0 , - \frac{{RT}_{60}}{6} {log}_{10} ( \frac{{\tilde{l}}_{i}}{{l}_{i}} ) ) \qquad ( 8 )$$

This is the nominal pause duration. Taking the maximum of the decay time value and 0 preserves the local time scale for lᵢ<\tilde{l}ᵢ.

The value for ξ may be chosen by the user. In an embodiment, ξ is −3 dB. The contribution of early reflections to intelligibility may be included in the value of ξ. As early reflections have a positive effect on intelligibility, a correspondingly lower value of ξ can be used, by estimating the power contribution from early reflections. An average adjustment can be used. For example, it 0 dB SLRR between the direct path and late reverberation is chosen to be acceptable for intelligibility, and early reflections are estimated to give an additional 3 dB boost for the particular area, the value for ξ is set as −3 dB.

In an embodiment, the pause duration is simply the time tᵢ.

In an alternative embodiment, the pause duration is calculated using the time tᵢ and a pause strength value. The pause strength is calculated in step S105. The pause duration is determined as a function of the pause strength and the time it takes the late reverberation to decay to a particular level, which is represented by the target late reverberation power. In this method, tᵢ is a nominal pause duration, determined such that a target SLRR is achieved. For example, tᵢ determined such that a target SLRR is achieved between the beginning, i.e. complete first sound transition of a word and the corresponding late reverberation power. This is then combined with the pause strength value to give a final pause duration. The joint effect of the two factors determines the effective pause duration such that increasing strength and higher reverberation time lead to longer pauses.

In an embodiment, the pause strength value is identified at the first location, wherein the first location is followed by the portion.

In an embodiment, the pause strengths are identified at the word boundaries for the sentence. The pause strength values may be identified for all the word boundaries in the sentence in one step, and the pause duration calculated for each location in the sentence in turn using the stored pause strengths.

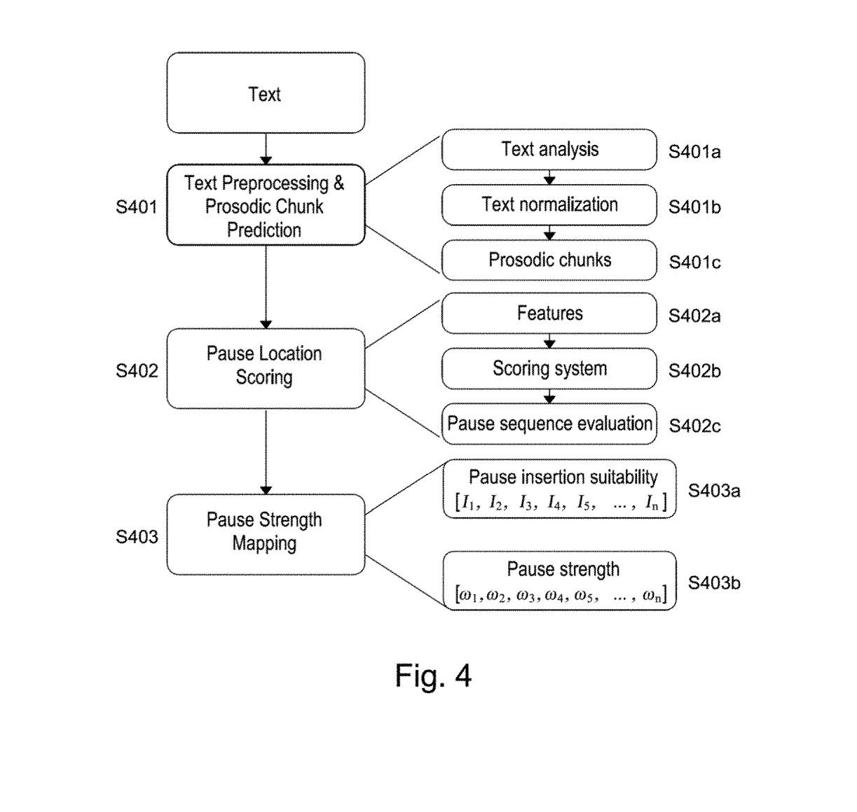

In an embodiment, pause strength assessment is performed from text using the multi-stage architecture shown in FIG. 4. This method of modifying the pause duration allows adaptation to the linguistic context and acoustic environment. The calculation of the pause duration thus employs a continuous indicator of pause strength, for example by providing a numeric value of greater than or equal to 0 and less than or equal to 1 indicating the level of pause strength.

FIG. 4 shows a flow chart of a method of calculating the pause strength which is part of a method of enhancing speech in accordance with an embodiment. The method of calculating the pause strength comprises determining a measure of the suitability for inserting a pause at each word boundary in a sentence in the text uₓ corresponding to the speech received by the speech input and mapping this value to a pause strength value.

In an embodiment, determining the pause strength comprises determining, from the text corresponding to the speech received by the speech input, whether each word boundary corresponds to a prosodic break in the text. This is determined in the step S401. In this embodiment, the measure of suitability, and thus the pause strength is obtained using natural language processing with machine learning algorithms, with the input being uₓ.

Step 401 is initial text pre-processing and prosodic chunk prediction. This step comprises step S401a, which is text analysis, step S401b, which is text normalization and step S401c, which is prosodic chunk prediction. The text pre-processing, i.e. text analysis and text normalization performed in this step may be performed by a trained Text-to-Speech system for example.

Step S401a “text analysis” may comprise splitting the input text into sentences, where multiple sentences are present. The text analysis may also comprise splitting the sentences into tokens, which are then looked up in a stored dictionary. For words not in the dictionary, the lexical information may be predicted. Then, the sentences may be part-of-speech tagged and parsed.

In step S401b the text is normalized. This may involve expansion of digits, abbreviations etc.

In step S401c, prosodic chunk prediction is performed. In an embodiment, the prosodic chunk prediction is performed using a decision tree model trained on a text-to-speech corpus. The model may be trained on a TTS corpus for example. In an embodiment, the corpus is labelled with Tone and Break Indices (ToBI). The corpus may be hand labelled or automatically labelled for example.

ToBI annotation has 5 basic levels in the break tier annotation, 0-4, corresponding to decreasing coupling between adjacent words and an increase in prosodic phrase boundary strength. Levels 0, 1 and 2 are grouped together as ‘non-breaks’, i.e. no prosodic phrase boundary, and levels 3 and 4 are merged into a single break level and considered as ‘breaks’, i.e. prosodic phrase boundaries.

The decision tree is trained to assign prosodic breaks to text using features derived from the text and its analysis. In step S401a the decision tree model predicts the relevant prosodic tag for each word juncture or boundary in the sentence. Prosodic tags are either a ‘break’ or ‘no break’ at each word juncture. For ‘breaks’, the ToBI break levels 3 and 4 are merged together as a single ‘break’ tag, thus identifying the presence of a phrase at the word juncture but not its strength. Thus presence or absence of a prosodic break is predicted for each word juncture, or word boundary, in the sentence. While prosodic chunks are used as input features, the final sequence of pauses is not restricted to prosodic chunk boundaries.

A first parameter corresponding to each word boundary is allocated a value of 0 if the word boundary does not correspond to a prosodic break and a pre-determined value of greater than zero if it does correspond to a prosodic break.

In an embodiment, the pre-determined value is 0.5. In this embodiment, for each word boundary in the sentence, there is a corresponding first parameter of either 0 or 0.5 allocated, depending on whether the boundary corresponds to a prosodic break.

In S402, the measure of suitability for inserting a pause at the word boundaries in the sentence is determined from the first parameter. In an embodiment, the measure of suitability is the first parameter.

In an alternative embodiment, determining the measure of suitability comprises determining, from the text corresponding to the speech received by the speech input, whether each word in the sentence satisfies one or more conditions from a pre-determined set comprising one or more conditions, wherein the conditions relate to features of the text, in step S402a, and allocating a value to a further parameter corresponding to each condition in the set, wherein the allocated value is zero if the word does not satisfy the condition and a pre-determined value other than zero if the word does satisfy the condition, in step S402b.

In this embodiment, machine learning algorithms are combined with rule-based methods to improve prediction performance. A multi-stage approach for pause strength prediction is used. In the first stage locations of prosodic chunk boundaries are predicted by a decision tree, the second stage combines these boundaries with other features in a scoring algorithm.

For each word in the sentence, a set of one or more further parameters, each having an allocated value is produced, each further parameter corresponding to a condition in the set. The allocated value for each further parameter is 0 or a pre-determined value other than zero, depending on whether the condition is satisfied for the word. The pre-determined value may be one of a range of values between 0 and a maximum value which depends on the condition.

A development data set including observations from multiple speech corpora may be used to generate the values that will be allocated to each parameter when the corresponding condition is fulfilled, during the initial, training stage. For example, the frequency of occurrence in the development data may be used to determine these values. The set of conditions and corresponding values are stored in the system. These values are the pre-determined values.

The pre-determined values may be positive or negative. A negative pre-determined value decreases the measure of suitability for a location. A negative pre-determined value is generated to reflect that particular conditions for pause insertion are not satisfied.

A condition in the set may relate to a single feature of the text, for example the part-of-speech for the word being “noun”, or may relate to a combination of features of the text, for example both the part-of-speech for the word being “noun” and the syntactic role of the word being “noun phrase”.

An example set of conditions and pre-determined values corresponding to each condition is shown in Table 1 below. However, many variations on the condition set and values are possible.

TABLE 1
Example condition set

| Condition | Pre-determined value |
|---|---|
| Part-of-speech for the word is “noun” and | .35 |
| syntactic role of word is “noun phrase” | |
| Part-of-speech for the word is “determiner” | −0.1 |
| Word follows punctuation | 1 |

In step S402b, the value of the first parameter is then combined with the allocated values for the further parameters for the word following the word boundary. In an embodiment, the values of the first parameter and the further parameters are summed. A weighted sum of the first parameter and the further parameter values may be taken. For example, the weight may be the number of parameters in which case the output value is an average of the value of the first parameter and the allocated values for the further parameters. The output value is the measure of suitability for inserting a pause at the location followed by the word.

In an embodiment, the output value is restricted to the range greater than or equal to 0 and less than or equal to 1. This may be enforced by checking the current value of the measure of suitability, before augmenting the measure of suitability with the value of the next further parameter. The measure of suitability is thus only augmented with the value of each further parameter on the conditions that: 1) the word satisfies the condition; and 2) the current value of the measure of suitability is greater than 0 where the condition corresponds to a negative pre-determined value and less than 1 where the condition corresponds to a positive predetermined value. In other words, the measure of suitability is continuously updated after each further parameter value is allocated.

This step outputs a continuous-valued score reflecting the suitability for inserting a pause at a location before each word. The score is the measure of suitability for inserting a pause at the word boundary.

The conditions relating to the features are thus used to generate a score for each word that determines the suitability for inserting a pause before the given word. The measure of suitability is based on values of further parameters which are defined in the scoring system for individual or combinations of characteristics. If a word is represented by a large number of non-zero further parameter values it will result in a higher score and if not it will receive a lower score.

The output of S402b thus comprises a measure of suitability for inserting a pause at each location followed by a word in the sentence. Thus in S402b, prosodic chunk boundaries are combined with other features in a scoring algorithm, which outputs continuous-valued scores reflecting the suitability for inserting a pause. In this case, the measure of suitability is influenced by prosodic boundary predictions, but may also be a non-zero value in locations which are not predicted as prosodic chunk boundaries. Thus the method is not restricted to only insert pauses at locations of predicted prosodic chunk boundaries.

In this step, prosodic chunks and additional conditions relating to features are combined in a scoring system. The additional conditions, which may relate to a single feature or a combination of features, are scored according to their relative contribution to the presence or absence of a pause. The result of the scoring is a numeric value, for example between 0 and 1, representing the measure of suitability for inserting a pause before each word in the input sentence.

In an embodiment, the scores are re-evaluated in step S402c before calculating the pause strength and pause duration, in a pause sequence evaluation module, to prevent extreme events such as: i) multiple consecutive pauses and/or ii) absence of pauses in long word sequences for example. Thus in this embodiment, the values output in step S402b are initial values of the measure of suitability. A pause sequence evaluation step then generates the final measures of suitability from these values.

The sequence evaluation step re-evaluates the sequence of predicted pauses given a threshold value, and may modify the measures of suitability, which may result in deleting or inserting pauses. The re-evaluated values are the final values of the measure of suitability. The step outputs a measure of suitability value for each word juncture in a given sentence. The threshold value may be defined by the user.

In an embodiment, S402c comprises determining whether the sentence comprises a sequence of two or more adjacent words for which the measure of suitability for inserting a pause at a location followed by the word is greater than a user defined first threshold value, and if there is such a sequence, re-evaluating the measures of suitability for the sequence. Re-evaluating the measures of suitability may comprise comparing the values of the measures of suitability in the sequence, and using the difference between the measure of suitability values, the difference between the measure of suitability values and the user defined first threshold value and whether each word satisfies one or more conditions relating to the features of the text to determine whether to “delete”, by reducing the measure of suitability for the location below the user defined first threshold, or keep, by retaining the original value for the measure of suitability, one or more of the pauses. In general, re-evaluating may comprise reducing the measures of suitability for one or more of the locations.

In an embodiment, S402c further comprises determining whether the sentence comprises a sequence of adjacent words for which the measure of suitability for inserting a pause at a location followed by the word is less than a user-defined second threshold value and if there is such a sequence, re-evaluating the measures of suitability for the sequence. The sequence may be a sequence of six or more words for example. Re-evaluating the measures of suitability may comprise comparing the values of the measures of suitability, and using the difference between the measure of suitability values, the difference between the measure of suitability values and the user defined first threshold value and whether each word satisfies one or more conditions relating to features of the text to determine whether to “add”, by increasing the measure of suitability for the location above the user defined first threshold or not, by retaining the original value for the measure of suitability, one or more of the pauses. The re-evaluation means that measures of suitability close to the threshold will be more likely to be increased. In general, re-evaluating may comprise increasing the measures of suitability for one or more of the locations.

Either or both types of re-evaluation may be performed. The first and second threshold values are defined by the user and may be the same value or different values. In an embodiment, the first and second threshold values are 0.95. The first and second threshold values may be determined by minimizing perceptual distortion as judged by a panel of listeners for a speech corpora. The differences between the measure of suitability values and the user defined threshold values which result in pause insertion or pause deletion may also be defined by the user, for example by evaluation speech corpora. In an embodiment, the user can alter the threshold value, enabling alteration of the pause insertion rate.

The output of this re-evaluation step is denoted by I, which is a set of final values for the measures of suitability for each word boundary in the sentence, where Iε[0,1].

Finally, each value of I is mapped to a pause strength value ω in step S403, outputting a set of pause strength values (ω₁, . . . , wₙ), each corresponding to a word boundary in the sentence, where ωε[0,1].

The pause strengths can be obtained in different formats by applying a particular mapping to I. In an embodiment, the pause strength values are calculated from a monotonically increasing function of the measure of suitability.

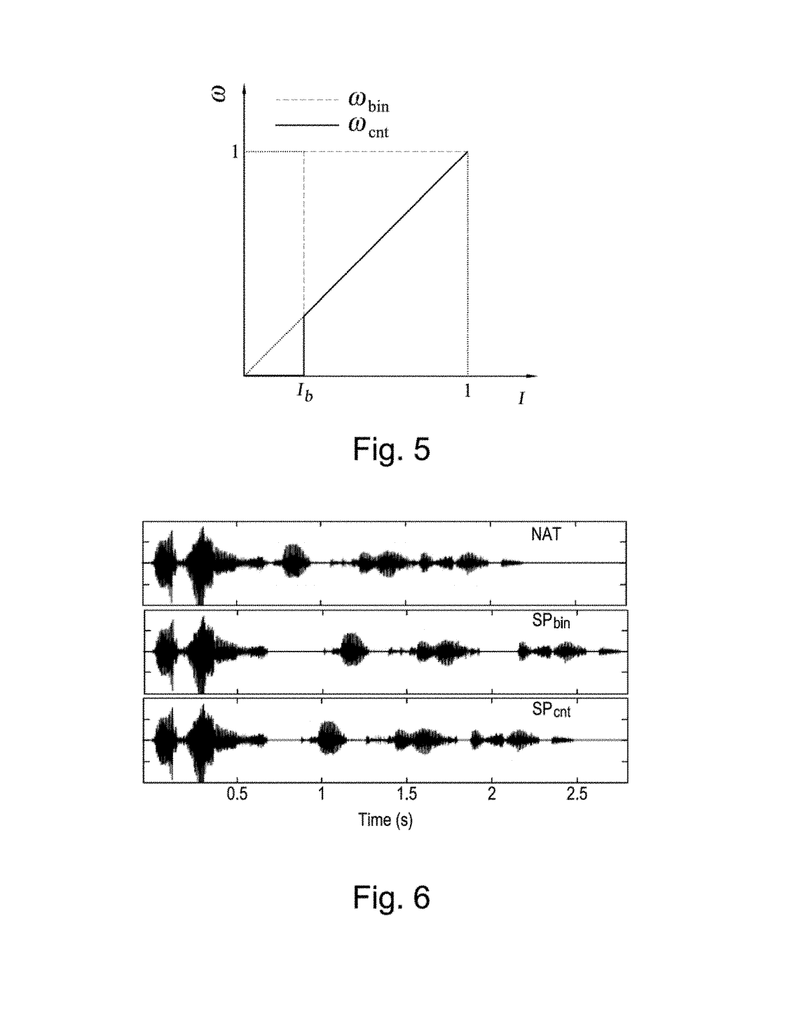

FIG. 5 illustrates some example functions which may be used to calculate the pause strength value using the measure of suitability. The measure of suitability is shown on the horizontal axis, with the pause strength on the vertical axis.

A first function is shown by the dashed line and results in binary-strength pauses based on a third threshold value I_{b}:

ω=0 I<I_{b}

ω=1 I≧I_{b} (9)

In an embodiment, I_{b} is 0.25. I_{b} may be determined during the training stage, or may be chosen by the user for example.

The second function is shown by the solid line and results in continuous-strength pauses extending above threshold value I_{b}:

ω=0 I<I_{b}

ω=I I≧I_{b} (10)

Use of a continuous pause strength allows for flexible adjustment of the pause duration.

In general, calculating the pause strength value may comprise assigning a pause strength value of 0 when the measure of suitability is less than I_{b}, and calculating a pause strength value from a monotonically increasing function of the measure of suitability when the measure of suitability is greater than or equal to I_{b}.

Use of I_{b} decreases the pause insertion rate and eliminates some of the spurious pauses caused by noise in the training data.

The output of step S105 comprises a value for the pause strength for the location followed by the portion, which may be referred to as the first location. In an embodiment, S105 is performed only once for each sentence, and the output of step S105 may be a set of values for the pause strength for each word boundary in the sentence. S105 is thus performed once for the entire sentence when the first portion is processed for example.

The pause duration, \tilde{t}ᵢ, for the first location is then calculated in S106 from:

\tilde{t}ᵢ=ωᵢtᵢ (11)

where ωᵢ is the pause strength, which may be calculated from (9) or (10) for example, and tᵢ is the time it takes the late reverberation power, generated by the preceding speech signal, to subside to a particular level, the target late reverberation power, and may be calculated from (8) for example.

Thus given the pause strength ωᵢ, lᵢ, ξ and the signal power xᵢ for the time window of the portion, the effective pause duration \tilde{t}ᵢ is computed.

By considering linguistic aspects through the pause strength, the resulting pause duration leads to natural and effective interruptions of the speech signal. The calculated pause duration adapts to the linguistic context and the properties of the environment.

In S107, a pause having the calculated duration is inserted into the speech received by the speech input at the first location, wherein the first location is followed by the portion. The first location corresponds to the word boundary for example.

For some of the word boundaries in the processed sentence, the calculated pause duration will be zero, for example where the pause strength value is zero, or is below I_{b}, or where there is little or no reverberation. For these locations, no pause is inserted, or equivalently, a pause having a duration of zero seconds is inserted.

The assigned pause is thus inserted in the output signal y followed by the word. Processing continues with the next word.

In an embodiment, the processing may be performed on one sentence of the speech signal at a time. For each sentence, the text corresponding to the entire sentence is processed to determine the segmentation information and to calculate a value for the pause strength corresponding to each word boundary. Then, a portion of the speech signal starting from each word boundary is extracted in order, and the contribution due to late reverberation of the speech when reverbed is estimated for the portion, from the previously modified section of the speech signal. This is used to calculate a time tᵢ for the estimated contribution due to late reverberation to decay to a target late reverberation power. The time tᵢ and the pause strength are used to calculate a pause duration for the word boundary. The pause is then inserted into the speech signal, and a new portion of the speech signal, corresponding to the next word boundary is extracted and processed. Once each word in the sentence has been processed, the next sentence in the signal is identified and processed in the same way.

FIG. 6 shows three output waveforms pre-processed for presentation at RT₆₀=1:8 s. The first waveform is natural speech and is used as a reference. The second waveform is modified by a speech enhancing method in accordance with an embodiment, in which a binary pause strength (SP_{bin}), based on equation (9) is used. The third waveform is modified by a speech enhancing method in accordance with an embodiment, in which a continuous pause strength (SP_{cnt}), based on equation (10) is used. I_{b}=0.25 was used.

Reverberation was simulated using a source-image method generated RIR. The assumed hall dimensions were 20×30×8 m, with speaker and listener locations {10, 5, 3} and {10, 25, 1.8} m respectively. For convenience, propagation delay and attenuation were normalized to the direct sound. A value of tₗ=0:05 s was assumed. The target SLLR ξ was set to −10 dB, reflecting the 10 dB power advantage of the direct signal and early reflections over late reverberation for the particular RIR realization. The two underlying assumptions were: i) the complete power advantage of early reflection over late reverberation translates to an intelligibility gain and ii) a 0 dB level for the ratio of the direct signal and early reflection to late reverberation is sufficient for accurate parsing of the pause-separated segments in a sentence.

The average sentence duration increase, as measured over 170 sentences is 16:9% for continuous-strength pauses and 26% for binary-strength pauses. Less than 2% of all sentences were not allocated any pauses using I_{b}=0.25. The effective pause durations increase with RT₆₀. In the absence of reverberation, no pauses will be inserted, or equivalently, pauses of zero duration will be inserted.

Considering a moderate reverberation condition and both binary and continuous pause strengths, a formal listening test was performed. A British English recording of the test sentences was used to conduct objective and subjective experiments. The results, which are shown in Table 3, show a significant intelligibility improvement over unmodified speech, while continuous pause strengths provide a higher intelligibility gain compared to binary pause strengths.

Table 2 presents the continuous and binary pause strengths preceding each word for the same test sentence used for the output waveforms. This example illustrates an advantage of using a continuous pause strength. The pause before “droop” is sub-optimally placed and receives full strength when binary mapping is used. The continuous-strength pause strength mapping de-emphasizes this pause.

TABLE 2
Pause strengths for a test sentence

| Text | Their | eyelids | droop | for | want | of | sleep |
|---|---|---|---|---|---|---|---|
| SP_{cnt} | — | 0 | .61 | 0 | 0 | .37 | 0 |
| SP_{bin} | — | 0 | 1 | 0 | 0 | 1 | 0 |

A subjective evaluation was also performed. A listening test with twelve naïve, i.e. without previous experience from intelligibility testing under reverberation, native English speakers of average age 24 was conducted to evaluate performance. The subjects did not report any hearing impairments and were paid for their participation. The material was presented diotically, in a soundproof booth using a pair of Sennheiser HD 558 headphones. Table 3 shows the individual mean word recognition rates at RT₆₀=1:8 s.

TABLE 3
Individual word recognition rates

| Subject | NAT | SP_{bin} | SP_{cnt} |
|---|---|---|---|
| 1 | 0.44 | 0.54 | 0.65 |
| 2 | 0.38 | 0.37 | 0.41 |
| 3 | 0.58 | 0.66 | 0.58 |
| 4 | 0.38 | 0.49 | 0.65 |
| 5 | 0.61 | 0.67 | 0.64 |
| 6 | 0.43 | 0.39 | 0.46 |
| 7 | 0.51 | 0.76 | 0.64 |
| 8 | 0.47 | 0.62 | 0.73 |
| 9 | 0.17 | 0.16 | 0.23 |
| 10 | 0.42 | 0.40 | 0.40 |
| 11 | 0.47 | 0.65 | 0.56 |
| 12 | 0.30 | 0.38 | 0.57 |
| mean | 0.43 | 0.51 | 0.54 |
| std | 0.12 | 0.17 | 0.14 |

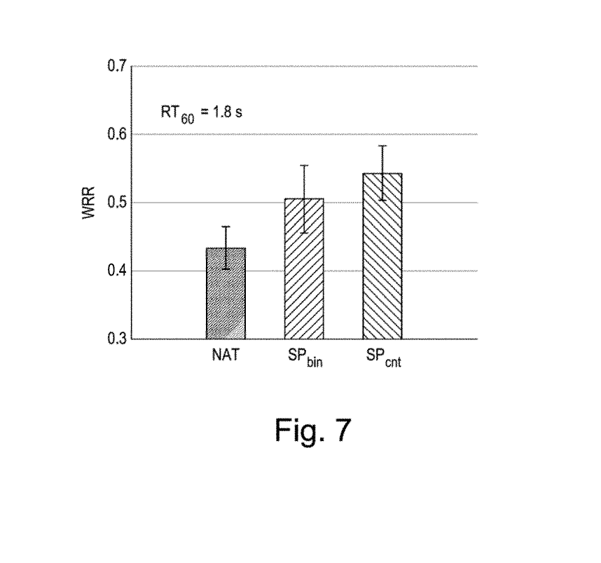

An initial session comprising ten sentences familiarized the listeners with the task and the test interface. Each method was assigned a macro set of four ten-sentence sets. The allocation of macro-set to system and the system presentation order were randomly selected for each listener. Upon hearing a sentence once, the listener was prompted to type its content. A word recognition rate was computed as the ratio of correctly-identified to the total number of key words in a sentence. The individual recognition rates over entire macro sets, with a mean over 40 sentences, are given in Table 3. Average word recognition rates over all test participants and standard errors for each method are shown in FIG. 7.

The results show that pause insertion improves intelligibility significantly, p<0:01, Student's t test, compared to un-modified speech. Continuous-strength pauses achieve higher intelligibility over binary-strength pauses, at a significantly shorter average duration, 16.9% absolute elongation on average for continuous against 26% for binary.

In an embodiment, further modification is performed on the output speech signal. For example, inserting pauses and preserving the prosody may lead to limited intelligibility gain. Thus in an embodiment, prosody modification may be performed. Pause insertion with prosody modification leads to an output speech signal which is closer to natural speech and may be less likely to confuse the listener.

In the above described embodiments, time-scale modifications are employed to reduce the effect of overlap-masking, by introducing linguistically-motivated pauses. Given text corresponding to a sentence of the speech signal, i.e. a transcription of the sentence, pause strengths may be predicted at the word boundaries in the sentence. A pause duration is obtained for each word boundary in sequence, by combining the pause strength and the time it takes late reverberation to decay to a level where a target signal-to-late-reverberation ratio criterion is satisfied.

Using the text corresponding to the speech signal, i.e. a sentence transcription, linguistically motivated pauses are inserted to improve intelligibility. A pause duration value is calculated for each word boundary in the sentence. A non-zero pause duration value is associated with a pause location, pause duration values of zero duration are locations where no pause is located. The selected locations of the pauses facilitate sentence parsing by listeners while maintaining a short overall sentence duration. In an embodiment, pause strengths are computed at word boundaries based on the text. Using a model of exponential decay for late reverberation power, the time separation needed to achieve a target signal-to-LR ratio is computed for the first sound transition in the word. The effective pause duration is obtained as the product of the pause strength and the time separation for achieving a pre-defined SLRR. Segmentation information is obtained by forced alignment using pre-trained GMM-HMMs.

In the above described embodiments, pause insertion is used for intelligibility enhancement of speech under reverberation. In some embodiments, a criterion that takes into account both the linguistic context and the specifics of the environment is used, providing flexibility.

In an embodiment, the speech intelligibility enhancing system is configured to perform a combination of speech modifications. In an embodiment, the pause insertion method is combined with adaptive gain control. In a further embodiment, the pause insertion method is combined with adaptive gain control and time warping. The processor is configured to extract a frame of the speech received from the speech input, calculate a measure of the frame importance, which reflects the degree of non-stationarity, estimate a contribution due to late reverberation to the frame power of the speech when reverbed, modify the frame gain of the speech received from the speech input, wherein the amount of modification is calculated using the measure of the frame importance and the contribution due to late reverberation, and apply local time warp. The above steps are performed on the input speech signal in combination with the pause insertion. In other words, these steps are performed on a frame by frame basis until a word boundary is reached. At this point, a pause duration is calculated and a pause inserted. This results in higher intelligibility gain and more natural sounding speech. It also results in shorter pause durations, as adaptive gain control reduces the reverberation power.

The speech modification method provides automated pause insertion for enhanced intelligibility in reverberant environments. The method is straightforward to realize and has low complexity, combined with autonomous operation.

The speech intelligibility enhancing system may be used for public announcements in enclosed spaces such as train stations, waiting and lecture halls, tunnels and covered stadiums, or for far field presentation for open spaces with long-delay reflections for example.

The speech modification method described above may be applied in the TTS domain such that the speech produced by the synthesizer contains pauses that take into account the linguistic context and the acoustic environment.

In an embodiment, the processor is configured to calculate a pause duration value for each word boundary. This allows insertion of pauses in locations where it is advantageous to insert a pause, i.e. only locations for which a non-zero pause duration is calculated. The duration reflects the level of reverberation as well as the likelihood of a human introducing a pause in a particular location. Pausing at linguistically motivated locations reduces distortion and improves the intelligibility gain, while keeping the waveform elongation small.

While certain arrangements have been described, these arrangements have been presented by way of example only, and are not intended to limit the scope of the inventions. Indeed, the apparatuses and methods described herein may be embodied in a variety of other forms; furthermore various omissions, substitutions and changes in the form of the apparatuses and methods described herein may be made.

1. A speech intelligibility enhancing system for enhancing speech, the system comprising:
a speech input for receiving speech to be enhanced;
an enhanced speech output to output the enhanced speech; and
a processor configured to convert speech received by the speech input to enhanced speech to be output by the enhanced speech output,
the processor being configured to:
extract a portion of the speech received by the speech input;
calculate the power of the portion;
estimate a contribution due to late reverberation to the power of the portion of the speech when reverbed;
calculate a target late reverberation power;
determine a time tᵢ for the estimated contribution due to late reverberation to decay to the target late reverberation power;
calculate a pause duration, wherein the pause duration is calculated using the time tᵢ;
insert a pause having the calculated duration into the speech received by the speech input at a first location, wherein the first location is followed by the portion.

2. The system according to claim 1, wherein the portion corresponds to at least the first part of a word.

3. The system according to claim 1, wherein the portion corresponds to the first sound transition of a word.

4. The system according to claim 1, wherein the portion corresponds to a fixed time window at the start of a word.

5. The system according to claim 2, wherein the portion is extracted from the speech received by the speech input by:
determining phone segmentation information using text corresponding to the speech received by the speech input and the speech received by the speech input.

6. The system according to claim 5, wherein the text is extracted from the speech received by the speech input using automatic speech recognition.

7. The system according to claim 1, wherein calculating the pause duration comprises:
determining a measure of the suitability for inserting a pause at the first location, using text corresponding to the speech received by the speech input;
wherein the pause duration is calculated using the time tᵢ and the measure of the suitability.

8. The system according to claim 7, wherein the portion corresponds to at least the first part of a word and determining the measure of suitability comprises:
determining, from the text corresponding to the speech received by the speech input, whether the first location corresponds to a prosodic break in the text, wherein the measure of suitability is higher if the first location corresponds to a prosodic break.

9. The system according to claim 8, wherein determining the measure of suitability comprises:
determining, from the text corresponding to the speech received by the speech input, whether the word satisfies one or more conditions from a pre-determined set comprising one or more conditions, wherein the conditions relate to features of the text.

10. The system according to claim 9, wherein determining the measure of suitability comprises:
allocating a first parameter a value of 0 if the first location does not correspond to a prosodic break and a pre-determined value of greater than zero if it does correspond to a prosodic break;
allocating a value to a further parameter corresponding to each condition in the set, wherein the allocated value is zero if the word does not satisfy the condition and a pre-determined value other than zero if the word does satisfy the condition;
calculating a value for the measure of the suitability by combining the values of the first parameter and the further parameters.

11. The system according to claim 7, wherein the speech received by the speech input comprises a sentence which is a sequence of words, and wherein the processor is configured to:
determine a measure of suitability for inserting a pause at each location followed by a word in the sentence;
determine whether the sentence comprises a sequence of two or more adjacent words for which the measure of suitability for inserting a pause at a location followed by a word is greater than a first threshold value;
if there is such a sequence, re-evaluate the measures of suitability for the sequence.

12. The system according to claim 7, wherein the speech received by the speech input comprises a sentence which is a sequence of words, and wherein the processor is configured to:
determine a measure of suitability for inserting a pause at each location followed by a word in the sentence;
determine whether the sentence comprises a sequence of six or more adjacent words for which the measure of suitability for inserting a pause at a location followed by the word is less than a second threshold value;
if there is such a sequence, re-evaluate the measures of suitability for the sequence.

13. The system according to claim 7, wherein calculating the pause duration comprises:
calculating a pause strength value wᵢ using the measure of suitability;
wherein the pause duration is calculated by multiplying the time tᵢ by the pause strength value wᵢ.

14. The system according to claim 13, wherein calculating the pause strength value wᵢ comprises assigning a pause strength value wᵢ of 1 when the measure of suitability is greater than or equal to a third threshold value I_{b} and assigning a pause strength value wᵢ of 0 when the measure of suitability is less than the third threshold value I_{b}.

15. The system according to claim 13, wherein calculating the pause strength value wᵢ comprises assigning a pause strength value wᵢ of 0 when the measure of suitability is less than a third threshold value I_{b}, and calculating a pause strength value wᵢ from a monotonically increasing function of the measure of suitability when the measure of suitability is greater than or equal to the third threshold value I_{b}.

16. The system according to claim 1, wherein the time tᵢ is calculated using an exponential decay function to model the decay of the power of late reverberation with time.

17. The system according to claim 1, wherein calculating the time tᵢ comprises:
calculating the logarithm of the target late reverberation power divided by the estimated contribution due to late reverberation to the power of the portion of the speech when reverbed;
scaling this calculated value using a reverberation time to give a decay time value;
wherein the time tᵢ is calculated as the maximum of the decay time value and 0.

18. The system according to claim 1, wherein the contribution due to late reverberation is estimated by:
modelling the impulse response of the environment as a pulse train that is amplitude-modulated with a decaying function;
taking the convolution of a section of the impulse response and a section of the enhanced speech signal located a time before the portion to give a model late reverberation signal for the portion;
calculating the power of the model late reverberation signal.

19. A method of enhancing speech, comprising:
extracting a portion of speech received by a speech input;
calculating the power of the portion;
estimating a contribution due to late reverberation to the power of the portion of the speech when reverbed;
calculating a target late reverberation power,
determining the time tᵢ for the estimated contribution due to late reverberation to decay to the target late reverberation power;
calculating a pause duration, wherein the pause duration is calculated using the time tᵢ;
inserting a pause having the calculated duration into the speech received by the speech input at a first location, wherein the first location is followed by the portion.

20. A carrier medium comprising computer readable code configured to cause a computer to perform the method of claim 19.
